(19) United States
(12) Patent Application Publication
(10) Pub. No.: US 2012/0144856 A1
(43) Pub. Date: Jun. 14, 2012

(54) REFRIGERATION UNIT WITH TUBE IN CHANNEL EVAPORATOR COIL

(76) Inventor: RUSSELL J. SHERLOCK, TORONTO (CA)

(21) Appl. No.: 13/267,759

(22) Filed: Oct. 6, 2011

Related U.S. Application Data
(60) Provisional application No. 61/421,082, filed on Dec. 8, 2010.

(51) Int. Cl. F25D 17/06; B23P 15/26

(52) U.S. Cl. 62/419; 29/890.035

(57) ABSTRACT

The refrigeration unit has a storage area for objects to be cooled. A channel having one or more evaporator coils is located within the storage area. A fan circulates air within the storage area through the channel past the one or more evaporator coils and circulates the air from a bottom of the channel through the storage area and back into an upper portion or the channel. Each evaporator coil preferably is located substantially within a vertical plane.

### BACKGROUND OF THE INVENTION

1. Field of the Invention

This invention relates to refrigeration units and more particularly to refrigeration units having one or more evaporator coils located within a channel located within a storage area for objects to be cooled within the refrigeration units and to a method of operation thereof.

2. Description of the Prior Art

Air-flow is a critical feature of self-contained commercial refrigerator units. The ability of a unit to achieve and maintain a temperature is reliant upon air-flow of a cooling system. Air-flow aids the maintenance of a consistently cool temperature within a refrigeration unit even when the unit is filled to its maximum capacity with product. In particular, air-flow can make a difference as to whether units perform at a level that meets set industry standards.

Another factor that is an important aspect of industry standards is the amount of product that a refrigeration unit must contain. This is known as pack-out. Standards for the maximum pack-out for refrigeration units of particular sizes are identified as the acceptable cabinet footprints for units. Any unit that does not meet industry standards will not have commercial applicability. Known refrigeration units apply cooling systems that are either static systems or of a forced-air finned-coil variety. A static cooling system may be either a non-forced-air gravity system, or a cold-wall (in-wall) system. Finned-coil cooling, systems may be finned-coil forced air evaporator cooling systems.

Static evaporator systems are generally inexpensive to manufacture. Such systems may also occupy less space within the interior cold cabinet of the refrigeration unit. This can create additional space within the interior cold cabinet for improved interior pack-out, meaning increased product storage. Static evaporator systems may further require less energy to operate than other systems. A drawback of static cooling systems is that they often lack the performance of other systems. For example, static systems often fail to achieve the pull-down of forced-air systems and therefore do not achieve a consistent temperature within the whole of the interior of the cold cabinet.

Forced-air systems achieve an improved cooling performance over static systems. However, such systems tend to have components that are of a higher cost, which can significantly affect the initial cost of a unit as well as future repair costs. Additionally, forced-air cooling systems occupy more space within the interior cold cabinet than other systems. Therefore, the cooling system diminishes the capacity of the interior cold cabinet to hold product, which makes optimum pack-out difficult to achieve. Forced-air cooling systems may also require more energy to perform at a level consistent with required industry standards. This causes an expenditure of energy resources and money.

It is necessary that a cooling system of a refrigeration unit include a condenser to achieve heat exchange. Static condenser coil systems are popularly applied in traditional refrigerators. The condenser coil is designed to extend outside the rear wall of the refrigeration unit, but not to cover the compressor compartment for the purpose of allowing ease of service for components in the compressor compartment. Known condenser coils are small and achieve performance that is below standards required for commercial use. With such condenser coils, it is often necessary to apply a cover over the compressor compartment for safety purposes and to minimize tampering.

### SUMMARY OF THE INVENTION

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.
A refrigeration unit comprising:
   (a) a cooling cabinet haying an access door to an interior thereof, the interior being a thermally insulated storage area for objects to be cooled;
   (b) the refrigeration unit having a top, bottom, two sides, a rear and a front with a motor and compressor being located in the refrigeration unit outside of the storage area, the motor being connected and being connected to drive the compressor, the two sides and rear being outer walls of the storage area;
   (c) an evaporator channel located within the storage area between the rear of the storage area and an inner wall that is spaced apart from the rear within the storage area, the evaporator channel having at least one substantially planar evaporator coil therein to cool air passing through the channel, the inner wall being constructed to allow air access between an upper portion of the storage area and a top of the channel and between a bottom of the channel and a lower portion of the storage area;
   (d) a fan located in the evaporator channel, the fan being rotatable to draw air into top of the evaporator channel from the upper portion of the storage area and to cause air within the evaporator channel to flow downward past the at least one evaporator coil and through at least one opening at or near a bottom of the inner channel into the lower portion of the storage area, the fan being strong enough relative to a size of the evaporator channel that air flows through the evaporator channel at a velocity resulting in turbulent air flow past the at least one coil;
   (e) at least one condenser coil located on an exterior of the refrigeration unit to dissipate heat to ambient air, and the compressor having an outlet to circulate refrigerant into the at least one condenser coil and an inlet to receive the refrigerant from the at least one evaporator coil;
   (f) the fan being operable to continuously circulate air within the storage area from the upper portion of a storage area downward through the channel, into the lower portion of the storage area and part the objects to be cooled back to the upper portion of the storage area; and
   (g) the refrigeration unit being connected to a power source.
A method of constructing a refrigeration unit having:
   (a) a cooling cabinet having an access door to an interior thereof, the cooling cabinet having a thermally insulated storage area for objects to be cooled;
   (b) the refrigeration unit having a top, bottom, two sides, a rear and a front with a motor and compressor being located in the refrigerator unit outside of the storage area, the motor being connected to drive the compressor, the refrigeration unit being connected to a power source;
   (c) at least one condenser coil located on an exterior of the refrigeration unit; the method comprising:
      (i) locating an inner wall inside the rear of the refrigeration unit within the storage area, thereby creating an evaporator channel between the rear of the cooling unit and the inner wall of the cooling unit, locating at least one evaporator coil within the channel, locating the fan in the channel, the inner wall being constructed to permit air access between an upper portion of the storage area and at or near a top of the channel, locating at least one opening at or near a bottom of the channel to allow air access between the channel and a lower portion of the storage area, constructing the fan to operate to draw air from the upper portion of the storage area into the channel and forcing the air downward past the at least one evaporator coil and out the at least one opening to a bottom portion of the storage area to recirculate the air within the refrigeration unit, sizing the channel and the fan to cause air in the channel to flow past the at least one evaporator coil at a velocity that results in turbulent air flow past the at least one evaporator coil; and
      (ii) operating the refrigeration unit to cause the fan to draw air from the upper portion of the storage area and to force the air downward through the channel past the at least one evaporator coil under turbulent flow conditions and out the at least one opening at the bottom of the channel into the lower portion of the storage area and continuing to recirculate the air within the refrigeration unit in that manner.
A refrigeration unit comprising:
   (a) a cooling cabinet having an access door to an interior thereof, the interior being a thermally insulated storage area for objects to be cooled;
   (b) the refrigeration unit having a top, bottom, two sides, a rear and a front with a motor and compressor being located in the refrigeration unit outside of the storage area, the motor being connected to drive the compressor, the two sides and rear being, outer walls of the storage area;
   (c) an evaporator channel located within the storage area between at least one of the rear, two sides and top of the storage area and an inner wall that is spaced apart from the at least one of the top, two sides and rear respectively of the storage area, the evaporator channel having at least one substantially planar evaporator coil therein to cool air passing through the channel, the inner wall being constructed to allow air access between one end of the channel and the storage area and between an opposite end of the channel and the storage area;
   (d) a fan located in the evaporator channel, the fan being rotatable to draw air into the evaporator channel from the storage area and to cause air within the evaporator channel to flow through the channel past the at least one evaporator coil and through at least one opening in the channel downstream from the evaporator coil into the storage area, the fan being strong enough relative to a size of the evaporator channel that air flows through the evaporator channel at a velocity resulting in turbulent air flow past the at least one coil;
   (e) at least one condenser coil located on an exterior of the refrigeration unit to dissipate heat to ambient air, and the compressor having an outlet to circulate refrigerant into the at least one condenser coil and an inlet to receive the refrigerant from the at least one evaporator coil;
   (f) the fan being operable to continuously circulate air within the storage area from the upper portion of a storage area downward through the channel, into the lower portion of the storage area and past the objects to be cooled back to the upper portion of the storage area; and
   (g) the refrigeration unit being connected to a power source.
A refrigeration unit comprising a cooling cabinet having an access door to an interior thereof, the interior being a thermally insulated storage area for objects to be cooled;
   (a) the refrigeration unit having a top, bottom, two sides, a rear and a front with a motor and compressor being located in the refrigeration unit outside of the storage area, the motor being connected to drive the compressor, the two sides and rear being outer walls of the storage area;
   (b) the refrigeration unit having an evaporator coil connected to an inlet of the compressor and a condenser coil being connected to an outlet of the compressor, the condenser coil being connected to the evaporator coil to form a cooling circuit for refrigerant with the compressor, the condenser coil being located outside of the cooling cabinet on at least one of said two sides and rear of the refrigeration unit, the condenser coil being substantially vertical when the refrigeration unit is in an upright position, a solid panel being located outside a lower portion of the condenser coil to form a channel between an inner surface of the panel and the at least one of the two sides and rear where the condenser coil is located, the lower portion of the condenser coil being located within the channel, a fan located on an upper portion of the at least two sides and rear where the condenser coil is located, the fan being located between an upper portion of the condenser coil and the at least one of the two sides and rear, the fan having blades to draw ambient air along an exterior of a bottom of the refrigeration unit and upward through the channel to the fan and outward from the fan through the upper portion of the condenser coil, the fan being operable to continuously circulate ambient air upward through the channel past the lower portion of the condenser coil located within the channel and upward past that portion of the condenser coil located outside of the channel to the fan and outward from the fan through the condenser coil; and
   (c) the refrigeration unit being connected to a power source.
A refrigeration unit comprising:
   (a) cooling cabinet having an access door to an interior thereof, the interior being a thermally insulated storage area for objects to be cooled;
   (b) the refrigeration unit having a top, bottom, two sides, a rear and a front with a motor and compressor being located in the refrigeration unit outside of the storage area, the motor being connected to drive the compressor, the two sides and rear being outer walls of the storage area;
   (c) an evaporator channel located within the storage area between at least one of the rear, two sides and top of the storage area and an inner wall that is spaced apart from the at least one of the top, two sides and rear respectively of the storage area, the evaporator channel having at least one evaporator coil therein to cool air passing through the channel, the at least one evaporator coil being sized and shaped to substantially fill a cross sectional area of said channel through a large portion of the length of the channel, the inner wall being constructed to allow air access between one end of the channel and the storage area and between an opposite end of the channel and the storage area;
   (d) a fan located in the evaporator channel, the fan being rotatable to draw air into the evaporator channel from the storage area and to cause air within the evaporator channel to flow through the channel past the at least one evaporator coil and through at least one opening in the channel downstream from the evaporator coil into the storage area, the fan being strong enough relative to a size of the evaporator channel and the at least one evaporator coil that air flows through the evaporator channel at a velocity resulting in turbulent air flow past the at least one coil;
   (e) at least one condenser coil located on an exterior of the refrigeration unit to dissipate heat to ambient air, and the compressor having an outlet to circulate refrigerant into the at least one condenser coil and an inlet to receive the refrigerant from the at least one evaporator coil;
   (f) the fan being operable to continuously circulate air within the storage area from the upper portion of a storage area downward through the channel, into the lower portion of the storage area and past the objects to be cooled back to the upper portion of the storage area; and
   (g) the refrigeration unit being connected to a power source.
A refrigeration unit comprising:
   (a) cooling cabinet having an access door to an interior thereof, the interior being a thermally insulated storage area for objects to be cooled;
   (b) the refrigeration unit having a top, bottom, two sides, a rear and a front with a motor and compressor being located in the refrigeration unit outside of the storage area, the motor being connected to drive the compressor, the two sides and rear being outer walls of the storage area;
   (c) an evaporator channel located within the storage area between at least one of the rear, two sides and top of the storage area and an inner wall that is spaced apart from the at least one of the top, two sides and rear respectively of the storage area, the evaporator channel having at least one evaporator coil therein to cool air passing through the channel, said evaporator channel having a narrow section, at least one evaporator coil being located in said narrow section and being sized and shaped to extend substantially from side to side, from front to rear and front end to end of said narrow section of said evaporator channel;
   (d) a fan located in the evaporator channel, the fan being rotatable to draw air into the evaporator channel from the storage area and to cause air within the evaporator channel to flow through the channel past the at least one evaporator coil and through at least one opening in the channel downstream from the evaporator coil into the storage area, the fan being strong enough relative to a size of the evaporator channel and the at least one evaporator coil that air flows through the evaporator channel at a velocity resulting in turbulent air flow past the at least one coil;
   (e) at least one condenser coil located on an exterior of the refrigeration unit to dissipate heat to ambient air, and the compressor having an outlet to circulate refrigerant into the at least one condenser coil and an inlet to receive the refrigerant from the at least one evaporator coil;
   (f) the fan being operable to continuously circulate air within the storage area from the upper portion of a storage area downward through the channel, into the lower portion of the storage area and past the objects to be cooled back to the upper portion or the storage area; and
   (g) the refrigeration unit being connected to a power source.

### BRIEF DESCRIPTION OF THE DRAWINGS

In the drawings:

FIG. 1 is a front view of a first embodiment of refrigerator unit having a single evaporation coil in accordance with the present invention;

FIG. 2 is a second embodiment of a refrigerator unit having a staggered evaporator coil;

FIG. 3 is a schematic side view of the refrigerator unit shown in FIG. 1 with a side wall removed to expose an interior;

FIG. 4 is a schematic side view of the refrigerator unit shown in FIG. 2 with a side wall removed to expose an interior;

FIG. 5 is a schematic side view of the refrigerator shown in FIG. 3 with a dual fan;

FIG. 6 is a schematic side view of the refrigerator shown in FIG. 2 with a dual fan;

FIG. 7 is a schematic top view of a refrigerator unit with a top portion removed to expose a fan;

FIG. 8 is a schematic top view of a refrigerator unit with a top portion removed to expose a dual fan in the refrigerator unit shown in FIG. 5;

FIG. 9 is an enlarged partial side view of a dual fan in the refrigerator unit of FIG. 5;

FIG. 10 is a rear view of a refrigerator unit showing a condenser coil and a real portion of a dual fan:

FIG. 11 is a rear view of a refrigerator unit showing a condenser coil extending along of the rear thereof;

FIG. 12 is a perspective view of a rear of the refrigeration unit shown in FIG. 11 with the condenser coil pivoted away from a rear of the unit;

FIG. 13 is a perspective view of a staggered evaporator coil when viewed from a side; and

FIG. 14 is a schematic view of a circuit diagram for refrigerant.

### DETAILED DESCRIPTION OF A PREFERRED EMBODIMENT

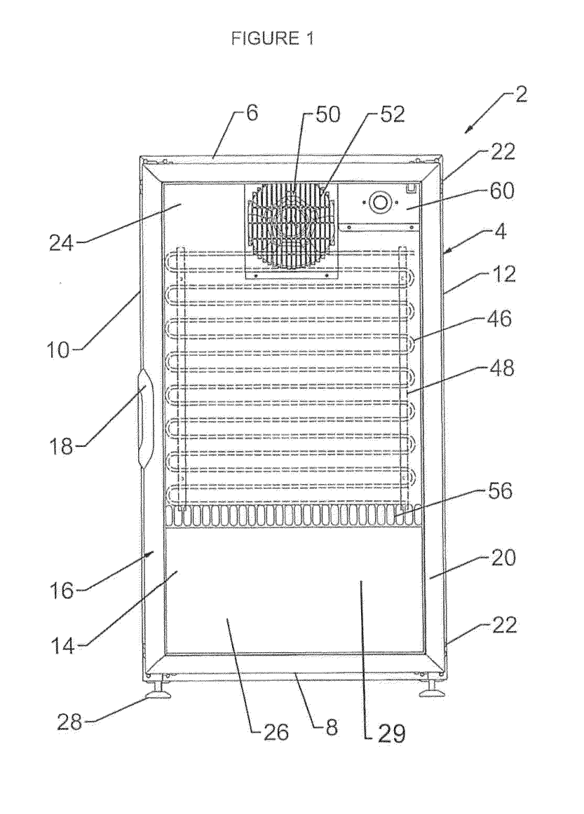

In FIG. 1, there shown a front view of a refrigeration unit 2 having a cooling cabinet 4. The refrigeration unit 2 has a top 6, bottom 8, two sides 10, 12, front 14 and rear (not shown in FIG. 1). A door 16 having a handle 18 and frame 20 is mounted on the front 14 by hinges 22. The frame 20 surrounds a glass panel 24. The door 16 is conventional and provides access to an interior of the cooling cabinet 4, which has a thermally insulated storage area 26 for storing objects (not shown) to be cooled. Various doors, including solid panel doors are suitable for the refrigeration unit 2. The thermal insulation is not shown and is conventional. The cooling cabinet has adjustable legs 28 (only two of which are shown), which are also conventional. An interior 29 of the refrigeration unit 2 can be seen through the glass panel 24.

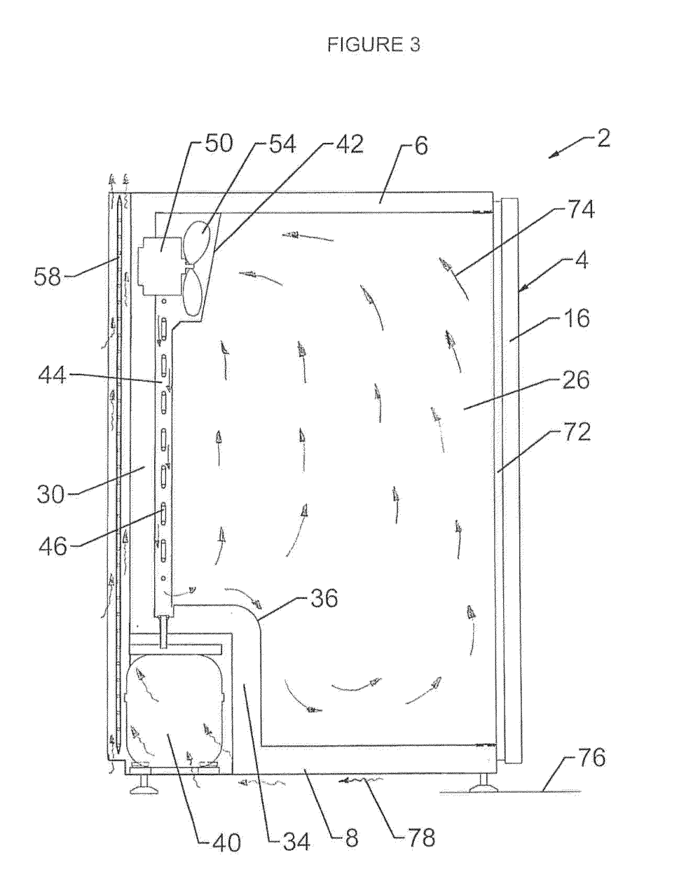

As best shown in FIG. 3, the refrigeration unit 2 has a rear 30 that comprises a rear wall extending from the top 6 toward the bottom 8. Near the bottom 8 of the refrigeration unit 2, the rear wall 30, connects to a step 34 that extends forward and downward to the bottom 8. Preferably, the step 34 has an inner corner 36 that is smoothly curved. The step 34 creates space outside of the thermally insulated storage area 26 for a compressor 40 and motor (not shown in FIG. 3) to be mounted, preferably at the bottom rear of the refrigeration unit 2. An inner wall 42 is spaced apart from the rear wall 30 within the storage area 26, thereby creating an evaporator channel 44 between an inner surface of the rear 30 and the inner wall 42. At least one substantially planar evaporator coil is located within the channel 44. The at least one evaporator coil 46 is mounted on brackets 48 and is shown as dotted lines in FIG. 1 as it is hidden from view by the inner wall 42 when viewed from a front of the refrigerator unit 2 shown in FIG. 1. The at least one evaporator coil preferably has a serpentine shape.

In FIGS. 1 and 3, the tube of the evaporator coil has long horizontal sections with alternating, curved ends to join the sections together in the serpentine configuration. It is not essential that the long sections of the evaporator coil be horizontal. The at least one evaporator coil is said to be substantially planar as the evaporator coil lies substantially within a vertical plane (best seen in FIG. 3) when the refrigeration unit 2 is in an upright position. The inner wall 42 is substantially parallel to the rear 30 in a lower portion of the channel 44, and extends inward to accommodate a fan 50 at an upper end of the channel 44. Preferably, the inner wall 42 is vented in an area of the fan 50 by vents 52. The fan 50 has blades 54. At a lower end of the channel 44 just above an intersection with the step 34, the channel has a plurality of openings 56 therein, preferably extending across an entire width of the channel 44. A condenser coil 58 is located on an exterior of the refrigeration unit 2 at the rear 30 thereof and preferably extends from the top 6 down to the bottom 8 so that it extends past the compressor 40 and motor (not shown in FIG. 3). In the upper right hand corner of the storage area 26 shown in FIG. 1, it can be seen that a controller 60 is mounted on the inner wall 42 to adjust the temperature of the storage area 26 within a predetermined range. The evaporator channel 44 shown in FIG. 3 should have a depth that is slightly larger than the at least one evaporator coil 46 and can be made narrower in the area of the evaporator coil by approximately 50% (not shown in FIG. 3) than the depth of the channel shown in FIG. 3.

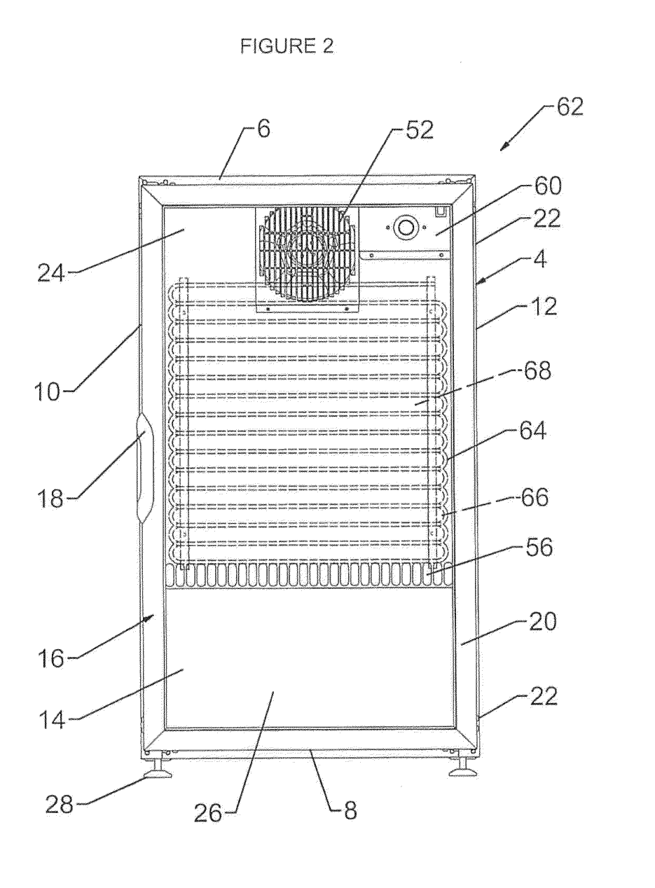

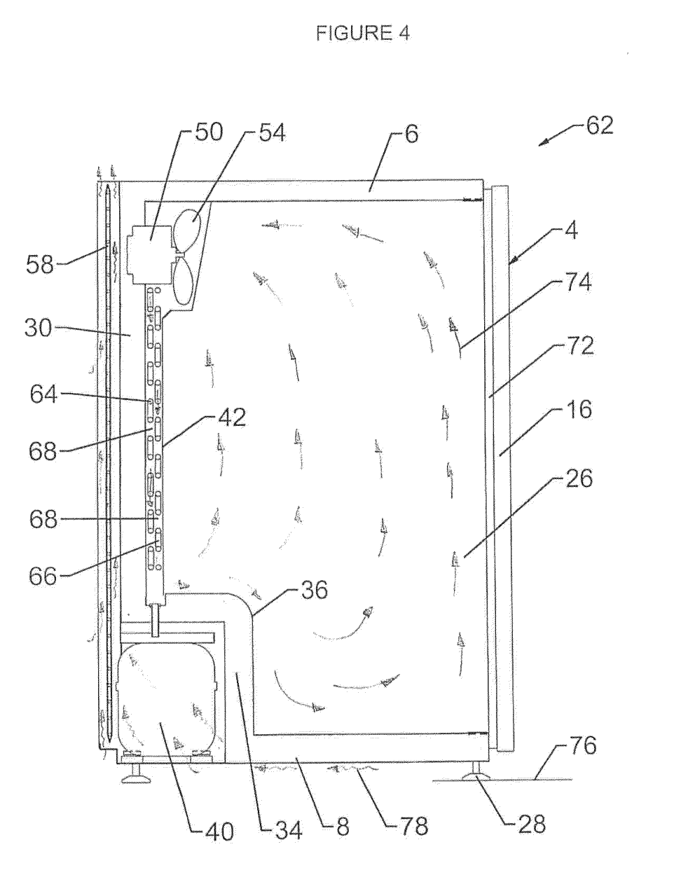

In FIGS. 2 and 4, there is shown a further embodiment of a refrigeration unit 62, which differs from the refrigeration unit 2 shown in FIGS. 1 and 3 in that the refrigeration unit 62 has two evaporator coils 64, 66 located in an evaporator channel 68 where the coils 64, 66 are located immediately adjacent to one another within the channel 68. It can be seen that the channel 68 has a lower portion that is narrow in the area of the coils 64, 66, but is sufficiently wide to accommodate a width of the evaporator coils 64, 66. The two evaporator coils 64, 66 are connected in parallel. The actual connection between the two evaporator coil 64, 66, each have long sections that are horizontal that are connected by curved ends and a serpentine configuration. The long sections can be angled to a non-horizontal configuration and the two portions can be offset by one another so that the long sections are not immediately adjacent as shown in FIGS. 2 and 4, but are offset so that the long sections of the first portion are higher or lower than the long sections of the second portion. In FIGS. 3 and 4, it can be seen that there is a conventional seal 72 between the door 16 and the top 6, bottom 8 and sides 10, 12 of the cooling cabinet 4.

The fan 50, the evaporator coil 46, and the two evaporator coils 64, 66 and the channels 44, 68 respectively are sized so that the forced airflow through the channels past the coils is at a velocity that results in turbulent airflow.

In operation, the refrigeration units 2, 62 operate in a similar manner with respect to airflow. On the evaporator side of the cycle within the thermally insulated storage area 26, there is a forced air system powered by the fan 50 to circulate air in accordance with the airflow arrows 74 shown in FIGS. 3 and 4. The fan 50 draws air in through the vents 52 (not shown in FIGS. 3 and 4) into the respective channels 44, 68 of the refrigeration units 2, 62. While the channel 44 is shown to have the same width as the channel 68, since the evaporator coil 46 is half as wide as the two evaporator coils 64, the channel 46 can be half as wide as that shown in FIG. 3. The refrigerator unit 2 would therefore have a larger pack-out than the refrigeration unit 62 because the channel 44 is narrower than the channel 68. The fan 50 forces the air within the channels 44, 68 downward past the evaporator coils within the channel at a velocity that results in turbulent flow of the air past the evaporator coils. The air within the channels 44, 68 is cooled as it passes the evaporator coil and is forced out the openings 56 in the bottom of the inner wall 42 (not shown in FIGS. 3 and 4).

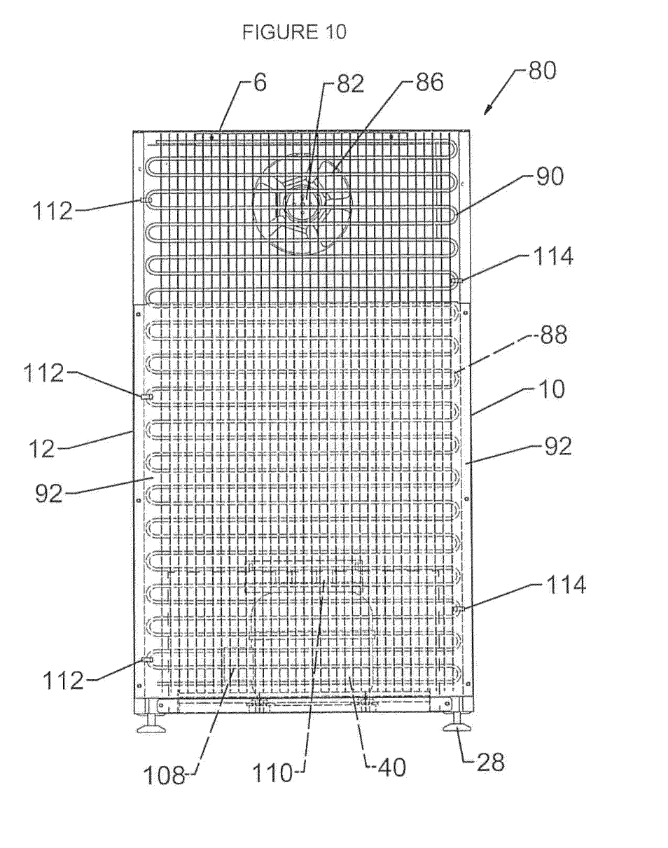

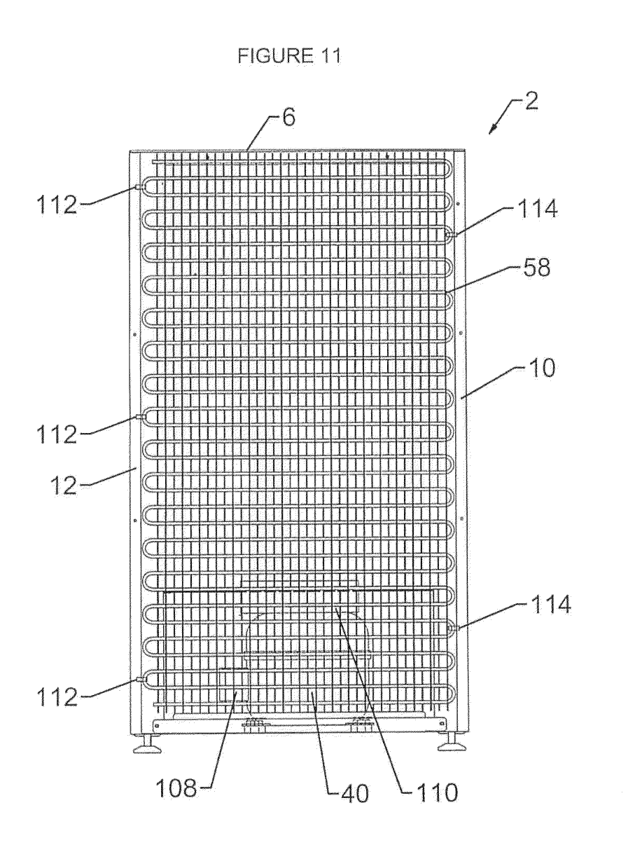

Since the air exiting from the openings 56 has just been cooled, it tends to fall down to the bottom 8 over the smoothly curved corner 36 of the indentation 34. The continuous flow of forced air causes the air in a bottom portion of the storage area 26 to be forced upward in the storage area to an upper portion where the fan 50 draws the air into the channel through the vents 52. The air in the upper portion of the storage area is warmer than the air in the lower portion of the storage area and the fan continuously circulates the air in a manner described as shown by the air flow arrows 74. Simultaneously, outside of the thermally insulated storage area 26, air is drawn in between a bottom of the refrigeration unit and a supporting surface 76 past the compressor 40 and upward along the condenser coil 58 by convection. The air flow past the condenser coil 58 flows out the top of the refrigeration unit as shown by squiggly arrows 78. The condenser coil 58 is connected to the compressor 40 and through an expansion valve (not shown) to the evaporator coils 46 and 64, 66. These connections of the circuit for the flow of refrigerant through the compressor and through the condenser coil and evaporator coils are conventional and are not shown. The condenser coil 58 also has a serpentine shape as shown in FIGS. 10 and 11 and, during operation of the unit, is hot at the top and cools toward the bottom. The refrigeration unit 62 shown in FIGS. 2 and 4 is the preferred embodiment. However, both embodiments result in a refrigeration unit that has maximum pack-out that is much larger for the footprint of the refrigeration unit than that achievable in previously refrigeration units with forced air systems. The refrigeration units 2 and 62 also operate at an efficiency level to exceed the applicable standards that is also not achievable by previous refrigeration units.

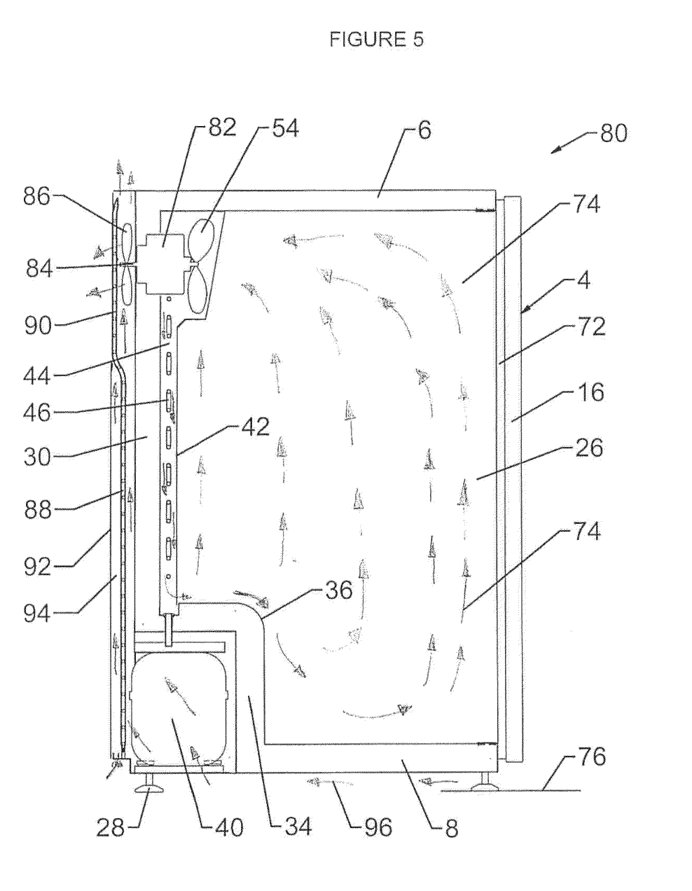

FIG. 5 is a schematic side view of a refrigeration unit 80 having a double fan 82 with a shall 84 extending out a rear of the fan through the rear 30 of the refrigerator unit 80 to power a second set of blades 86. A condenser coil 88 has an upper portion 90 that curves rearward to accommodate the blades 86 of the fan 82. A vertical panel 92 extends vertically from the bottom of the refrigeration unit 80 upward to the beginning of the curved portion 90 to create a condenser channel 94 between the panel 92 and the rear 30 of the refrigeration unit 80. The rotation of the fan blades 86 draws the air upward and outwards from a lower portion of the condenser coil 88 and between the supporting surface 76 and the bottom 8 of the refrigeration unit 2 as shown by the flow arrows 96. The fan 82 has a single motor powering both a first set of blades 54 and the blades 86. The refrigeration unit 80 has the evaporator coil 46 in the channel 44.

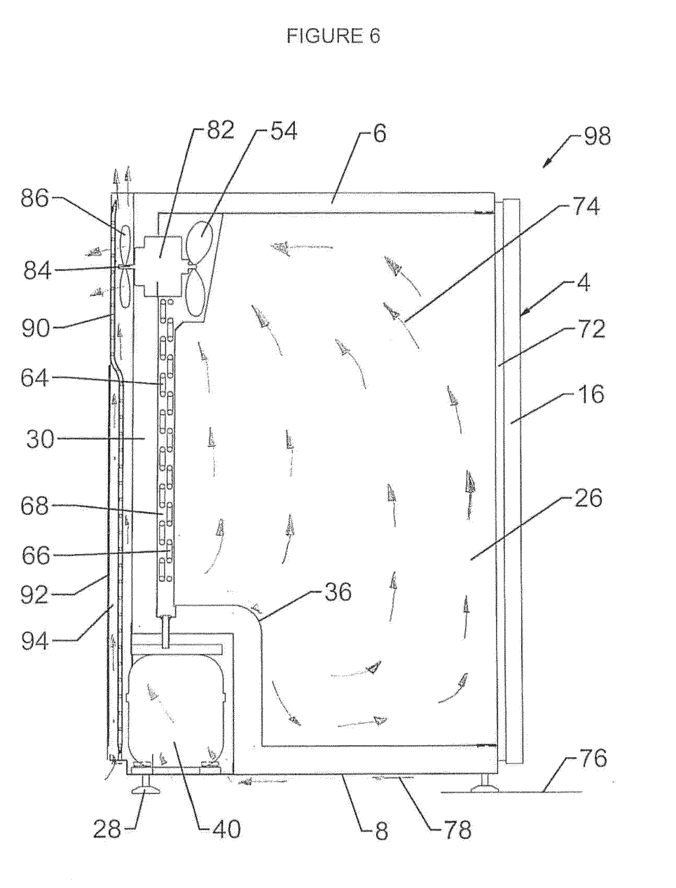

In FIG. 6, there shown a further embodiment of a refrigeration unit 98 that is identical to the refrigeration unit 80 except that the refrigeration unit 98 has the evaporator coil 64 located in the channel 66.

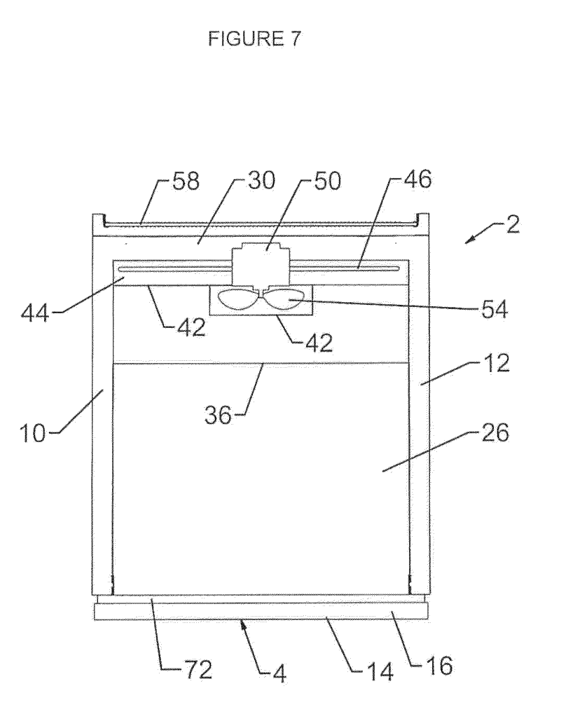

FIG. 7 is schematic top view of the refrigeration unit 2 with a top removed to expose the interior 26. A top view of the refrigeration unit 62 would be identical to FIG. 7 except for any variation in the width of the channel.

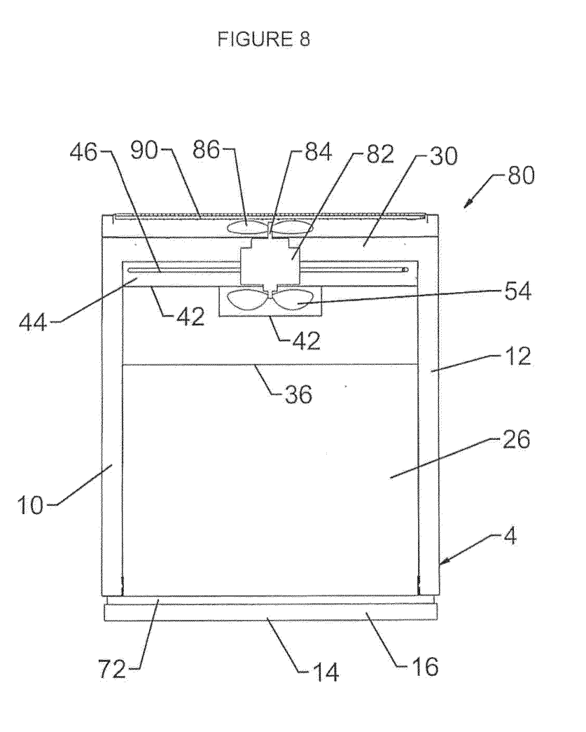

FIG. 8 is a schematic top view of the refrigeration unit 80 having the double fan 82 with a top removed to expose the interior of the storage area 26. A top view of the refrigeration unit 98 would be the same as that shown in FIG. 8 except for any variation in the width of the channel compared to the refrigeration unit 80.

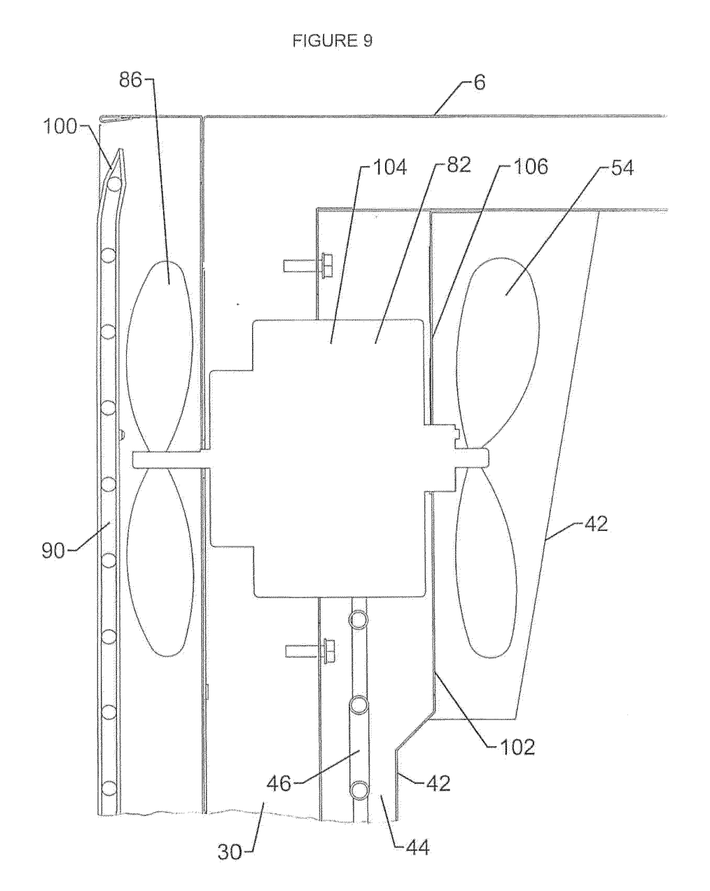

FIG. 9 is a schematic partial side view of the double fan 82 and upper tip 100 of the upper portion 90 of the condenser coil 88, which is curved slightly forward toward the rear 30 of the cooling cabinet 4. A harrier 102 extends across the channel 44 between the blades 54 of the fan 50 and a motor 104. The barrier 102 has adjustable openings 106 therein to control the velocity of the air flow through the storage area 26 without adjusting the RPM of the blades 54.

FIG. 10 is a rear view of the refrigeration unit 80. A motor (not shown) is located inside of the compressor 40 and powers the compressor 40. A controller 108 is located adjacent to the compressor. The condenser coil 88 has a serpentine configuration. A drip pan 110 is located beneath the compressor 40. A rear view (not shown) of the refrigeration unit 98 is identical to the rear view of the refrigeration unit 80. The double fan 82 is visible at the rear 30.

In FIG. 11, there shown a rear view of the refrigeration unit 2. A rear view (not shown) of the refrigeration unit 62 is identical to the rear view of the refrigeration unit 2.

In FIGS. 10 and 11, the condenser coils 88, 58 respectively cover the space that includes the compressor 40 and controller 108. The condenser coils 88, 58 are attached to a rear of the refrigeration units 80, 2 respectively by hinges 112 on the side 10 and fasteners 114 on the side 12. When access to the space where the controller 108 and compressor 40 are located is required for any reason, the fasteners 114 can be opened and the condenser coils 88, 58 can be pivoted away from the rear of the refrigeration unit on the hinges 112.

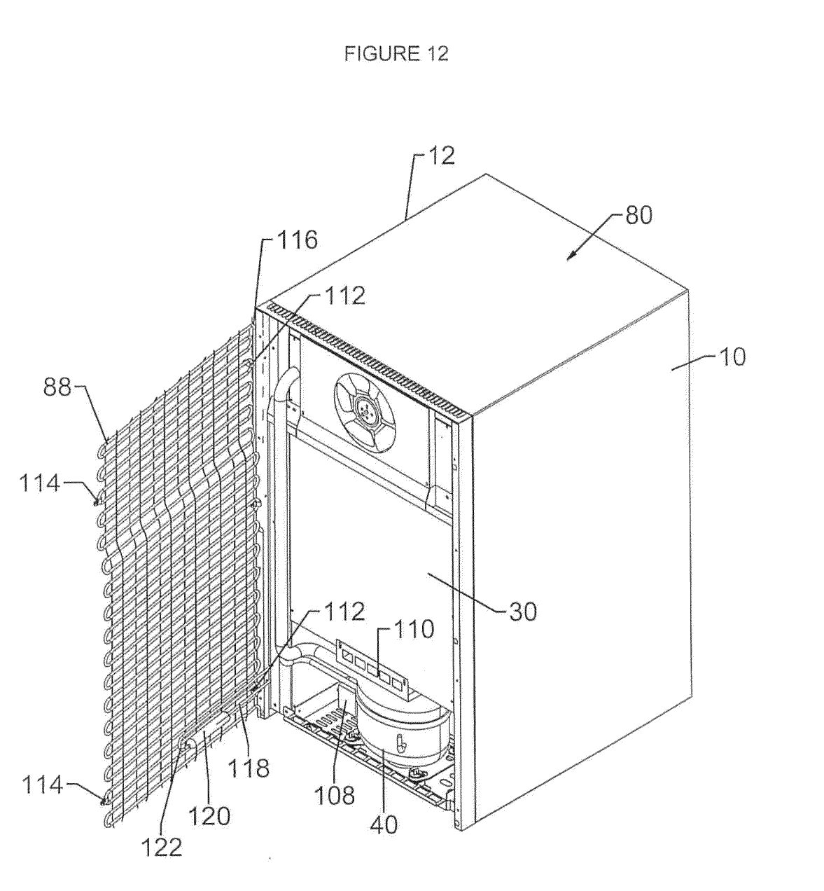

In FIG. 12, there shown a perspective view from a rear of the refrigeration unit 80 with the condenser coil 88 pivoted clockwise away from the rear 30 of the refrigeration unit 80. In a bottom rear of the refrigeration unit, there shown the compressor 40 and the controller 108. A motor (not shown) is located inside of the compressor and powers the compressor. A tube 116 extends from the compressor 40 and upward along a rear of the refrigeration unit 80 near a side 12 where it is connected into a top of the condenser coil 88. The condenser coil 88 has a serpentine shape and the refrigerant exiting from the compressor 40 flows through the tube 116 and through the condenser coil 88. The refrigerant exits the condenser coil 88 at a bottom thereof and flows through an inlet tube 118 through a desiccant (a trade mark) dryer 120. An outlet tube 122 extends to a capillary tube (not shown) located inside an insulated tube 124. The capillary tube connects into the evaporator coil 46 (not shown in FIG. 12). The evaporator coil is connected into the compressor to complete the circuit for the refrigerant.

The condenser coil 88 has hinges 112 connected thereto to allow the condenser coil to pivot away from a rear of the refrigeration unit when it is necessary to access any part of the rear 30 of the refrigeration unit 80. For example, if repairs are necessary to the compressor 40, controller 108 or other components of the refrigeration unit for which access is required from the rear, the condenser coil can be pivoted away from the refrigeration unit. The fasteners 114 located on the condenser coil 88 on a side opposite to the hinges 112 can be closed to retain the condenser coil against the rear of the refrigeration unit or opened to pivot the evaporator coil away from the refrigerator. The tubes containing refrigerant are metal tubes and are preferably copper tubes. The tubes will twist slightly when the condenser coil is pivoted to the open position shown in FIG. 12 or the closed position shown in FIG. 10. The drip pan 110 is located above the compressor 40 to collect moisture from the evaporator coil (not shown in FIG. 12).

Preferably, both the evaporator coils are made from one continuous tube of material for each refrigeration unit and preferably the condenser coils are also made from one continuous tube of material for each refrigeration unit.

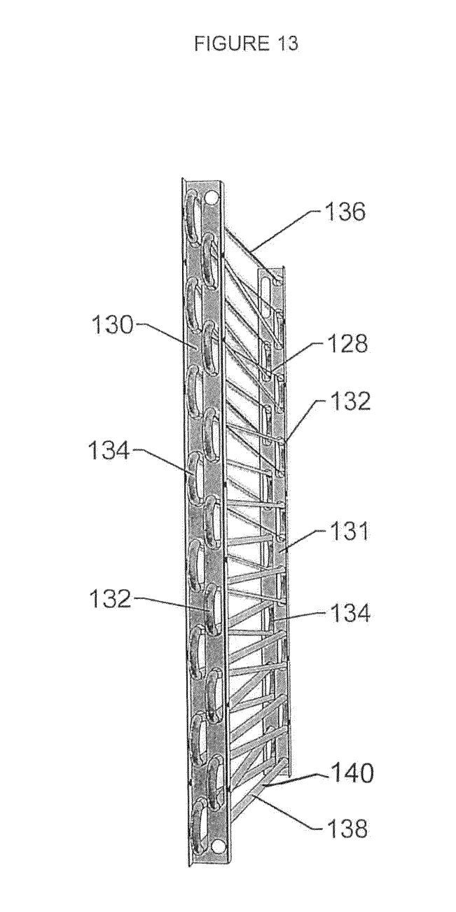

In FIG. 13, an evaporator coil 128 is mounted in two side brackets 130, 131. The coil 128 and side brackets 130 are sized to fit within the channel 44 (not shown) of the refrigeration unit 62 shown in FIGS. 2 and 4. The evaporator coil 128 has a front 132, a rear 134, a top 136 and a bottom 138. Commencing at a bottom 138. it can be seen that a tube 140 extends from a front of the side 131 to a rear of the side bracket 130 and loops upward 180 degrees at the side bracket 130 and extends back to the rear of the side bracket 131. The tube 140 then loops upward at the rear of the side bracket 131 and extends to the front of the side bracket 130 where it loops upward 180 degrees and extends to the front of the side bracket 131 where it loops upward 180 degrees and extends to the rear of the side bracket 130. This pattern continues right to the top 136 with the tube 140 of the evaporator coil 128 alternating from side to side between a front and rear of the side brackets 130 and 131 until the coil ends, shown in FIG. 13. A last portion of the tube 140 extends to the front of the side bracket 131. The evaporator coil 128 shown in FIG. 13 is said to have a staggered shape.

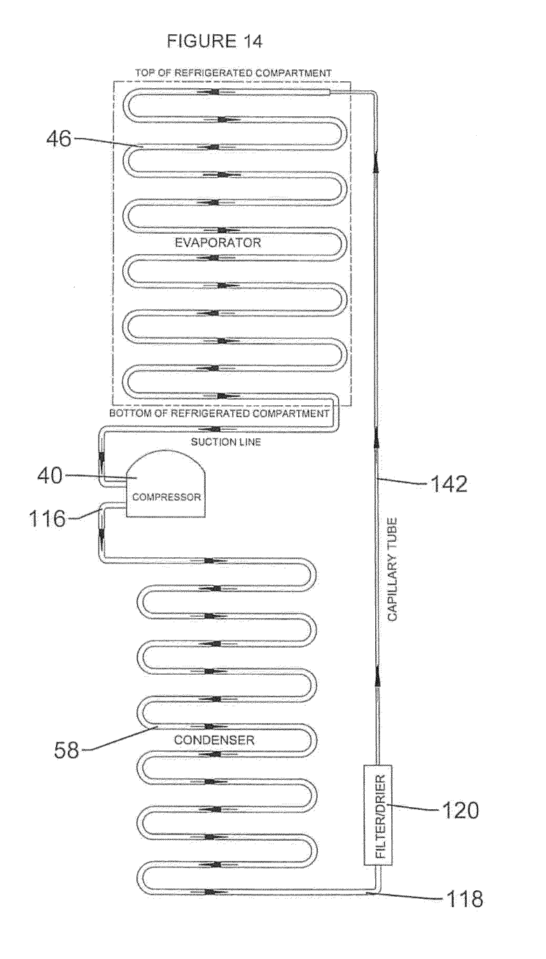

In FIG. 14, there is shown a schematic circuit diagram for refrigerant in a refrigeration unit of the invention. A capillary tube extends from the filter/dryer 120 to a top of the evaporator coil 46. While the evaporator coil 46 is referred to in FIG. 14, any of the evaporator coils described herein can be used in the refrigerant circuit shown. Similarly, while the reference numeral 58 is used for the condenser coil, any of the condenser coils described herein can be used in the refrigerant circuit. Commencing at the compressor, refrigerant flowing from the outlet of the compressor 40 is hot under high pressure and in vapour form. As the refrigerant passes through the condenser, it cools and changes to a liquid form. When pressure decreases as the refrigerant flows from the capillary tube to the larger diameter evaporator tube, part of the refrigerant returns to a vapour form.

In all of the Figures, the same reference numerals are used to describe those components that are identical to the components in Figures that have been previously described unless otherwise indicated.

The refrigeration unit in accordance with the present invention incorporates a forced-air tube-in-channel evaporator coil having a low temperature heat absorption evaporator tubing formed as a continuous planar coil. The refrigeration unit has a minimal footprint based upon the storage area available. The additional storage area results from the narrow passageway within the refrigeration unit. The condenser coil facilitates the compressor compartment safety by covering a compartment that contains the motor and compressor that simultaneously permits easy access to the motor and compressor.

Though the rear wall is preferred, the continuous virtually flat evaporator coil of the refrigeration unit may be housed within a narrow passage way on any wall or ceiling of the storage area of the refrigeration unit. The design of the refrigeration unit provides a storage area that is increased in size over previous units having the same footprint. The evaporator coil can be a single layer coil or a multi-layer coil in which each layer lies within a vertical plane, there being one vertical plane for each layer.

Frosting of the refrigeration unit is reduced due to the shape of the forced-air tube-in-channel evaporator coil, which does not have any tins. Previous evaporator coils with fins frequently experience frosting because the frost bridges the space between the fins. The increased air flow of the refrigeration unit promotes more efficient cooling.

The evaporator coil is preferably formed from a single tube, at least for each layer. The evaporator coil does not have fins and fins not only make the evaporator coil much more expensive to manufacture but the fins also require skilled fabricators whereas a continuous tube evaporator coil of the present invention can be constructed, without welds, by persons of ordinary skill and knowledge. The fact that at least each layer of the evaporator coil is one piece, eliminates the need for welding two or more parts of the evaporator coil together. Welding also requires special skills and welded evaporator tubes are much more expensive to operate.

The evaporator coil can be attached to a wall of the refrigeration unit by brackets or other attachment means. The brackets can be channelled brackets.

The fan can be located in various locations within the storage area and is preferably located within the channel and still more preferably located at the top of the channel. The motor for the fan is preferably embedded in a wall of the refrigeration unit and the blades are preferably oriented in a plane substantially parallel to the channel. The fan motor can also be mounted externally of the cooling cabinet. The refrigeration unit can provide rear access to the fan motor so that repairs can be made from the rear of the refrigeration unit.

The size and shape of the channel and the evaporator coil and size and positioning of the fan motor and blades result in the refrigeration unit of the present invention providing maximum usable storage area for objects to be cooled, thereby providing greater pack-out than prior refrigeration units while meeting or exceeding the industry standards required for pull-down and performance. The shape of the evaporator coil can take various forms (including an offset shape, staggered alternating shape and a bow-tie shape) provided that the evaporator coil is substantially planar. The channel can contain one or more evaporator coils.

While the fan and channel shown in the drawings circulates air from top to bottom in the channel into a lower portion of the storage area and upward through the storage area to the upper portion of the storage area and back into the upper part of the channel, and while that direction of air flow is preferred, the refrigeration unit can be designed for airflow in the opposite direction.

The smoothly curved corner 36 allows cold air flowing from the bottom of the channel into the usable storage area to flow smoothly down into the bottom of the usable storage area over the corner. This provides good circulation for the lower portion of the usable storage area and may result in reduce static pressure within the storage area.

The condenser coil can be any suitable shape including an offset shape, staggered alternating shape or an alternating bow-tie shape.

1. A refrigeration unit comprising:
(a) cooling cabinet having an access door to an interior thereof, the interior being a thermally insulated storage area for objects to be cooled;
(b) the refrigeration unit having a top, bottom, two sides, a rear and a front with a motor and compressor being located in the refrigeration unit outside of the storage area, the motor being connected to drive the compressor, the two sides and rear being outer walls of the storage area;
(c) an evaporator channel located within the storage area between at least one of the rear, two sides and top of the storage area and an inner wall that is spaced apart from the at least one of the top, two sides and rear respectively of the storage area, the evaporator channel having at least one evaporator coil therein to cool air passing through the channel, the at least one evaporator coil being sized and shaped to substantially fill a cross sectional area of said channel through a large portion of the length of the channel, the inner wall being constructed to allow air access between one end of the channel and the storage area and between an opposite end of the channel and the storage area;
(d) a fan located in the evaporator channel, the fan being rotatable to draw air into the evaporator channel from the storage area and to cause air within the evaporator channel to flow through the channel past the at least one evaporator coil and through at least one opening in the channel downstream from the evaporator coil into the storage area, the fan being strong enough relative to a size of the evaporator channel and the at least one evaporator coil that air flows through the evaporator channel at a velocity resulting in turbulent air flow past the at least one coil;
(e) at least one condenser coil located on an exterior of the refrigeration unit to dissipate heat to ambient air, and the compressor having an outlet to circulate refrigerant into the at least one condenser coil and an inlet to receive the refrigerant from the at least one evaporator coil;
(f) the fan being operable to continuously circulate air within the storage area from the upper portion of a storage area downward through the channel, into the lower portion of the storage area and past the objects to be cooled back to the upper portion of the storage area; and
(g) the refrigeration unit being connected to a power source.

2. A refrigeration unit is claimed in claim 1 wherein the evaporator channel has a narrow section, the at least one evaporator coil being located in said narrow section and being sized and shaped to extend substantially from side to side, from front to rear and from inlet end and to outlet end of said narrow section.

3. A refrigeration unit is claimed in claim 1 wherein the evaporator channel has at least one substantially plainer evaporator coil therein.

4. A refrigeration unit is claimed in claim 1 wherein the evaporator channel is a vertical channel when the refrigeration unit is in an upright position and airflow through the channel from an upper portion of the storage area into a top of the channel, downward through the channel and out a bottom of the channel to a lower portion of the storage area.

5. A refrigeration unit as claimed in claim 4 wherein the evaporator channel is located at the rear of the storage area.

6. A refrigeration unit as claimed in claim 1 wherein the evaporator coil does not have any fins thereon.

7. A refrigeration unit as claimed in claim 6 wherein the at least one evaporator coil has a serpentine shape.

8. A refrigeration unit as claimed in claim 6 wherein the at least one condenser coil has a serpentine shape that lies substantially within a vertical plane when the refrigeration unit is in an upright position.

9. A refrigeration unit as claimed in claim 8 wherein the at least one evaporator coil is a first evaporator coil and there is a second evaporator coil lying in a second vertical plane adjacent to the first evaporator coil.

10. A refrigeration unit as claimed in claim 9 wherein the first evaporator coil and the second evaporator coil are connected in parallel.

11. A refrigeration unit as claimed in any one of claim 1, 2 or 6 wherein the channel has a depth that is slightly larger than a depth of the evaporator coil.

12. A refrigeration unit as claimed in any one of claim 1, 2 or 3 wherein the condenser coil has a serpentine shape and is located at the rear of the refrigeration unit and extends to a bottom of the refrigeration unit, one side of the condenser coil being mounted on hinges and the condenser coil being connected to the condenser in a flexible matter to allow the condenser coil to pivot away from the rear of the refrigeration unit to allow access to the condenser and motor from the rear of the unit.

13. A refrigeration unit as claimed in any one of claims 1, 2 or 3 wherein the at least one evaporation coil has a staggered shape, a tube of the at least one evaporator coil extending from side to side of said channel and alternately from front to rear of said channel.

14. A refrigeration unit comprising a cooling cabinet having an access door to an interior thereof, the interior being a thermally insulated storage area for objects to be cooled;
(a) the refrigeration unit having a top, bottom, two sides, a rear and a front with a motor and compressor being located in the refrigeration unit outside of the storage area, the motor being connected to drive the compressor, the two sides and rear being outer walls of the storage area;
(b) the refrigeration unit having an evaporator coil connected to an inlet of the compressor and a condenser coil being connected to an outlet of the compressor, the condenser coil being connected to the evaporator coil to form a cooling circuit for refrigerant with the compressor, the condenser coil being located outside of the cooling cabinet on at least one of said two sides and rear of the refrigeration unit, the condenser coil being substantially vertical when the refrigeration unit is in an upright position, a solid panel being located outside a lower portion of the condenser coil to form a channel between an inner surface of the panel and the at least one of the two sides and rear where the condenser coil is located, the lower portion of the condenser coil being located within the channel, a fan located on an upper portion of the at least two sides and rear where the condenser coil is located, the fan being located between an upper portion of the condenser coil and the at least one of the two sides and rear, the fan having blades to draw ambient air along an exterior of a bottom of the refrigeration unit and upward through the channel to the fan and outward from the fan through the upper portion of the condenser coil, the fan being operable to continuously circulate ambient air upward through the channel past the lower portion of the condenser coil located within the channel and upward past that portion of the condenser coil located outside of the channel to the fan and outward from the fan through the condenser coil; and
(c) the refrigeration unit being connected to a power source.

15. A method of constructing a refrigeration unit having:
(a) a cooling cabinet having an access door to an interior thereof, the cooling cabinet having a thermally insulated storage area for objects to be cooled;
(b) the refrigeration unit having a top, bottom, two sides, a rear and a front with a motor and compressor being located in the refrigeration unit outside of the storage area, the motor being connected to drive the compressor, the refrigeration unit being connected to a power source;
(c) at least one condenser coil located on an exterior of the refrigeration unit; the method comprising:
(i) locating an inner wall inside the rear of the refrigeration unit within the storage area, thereby creating an evaporator channel between the rear of the cooling unit and the inner wall of the cooling unit, locating at least one evaporator coil within the channel, locating the fan in the channel, the inner wall being constructed to permit air access between an upper portion of the storage area and at or near a top of the channel, locating at least one opening at or near a bottom of the channel to allow air access between the channel and a lower portion of the storage area, constructing the fan to operate to draw air from the upper portion of the storage area into the channel and forcing the air downward past the at least one evaporator coil and out the at least one opening to a bottom portion of the storage area to recirculate the air within the refrigeration unit, sizing the channel and the fan to cause air in the channel to flow past the at least one evaporator coil at a velocity that results in turbulent air flow past the at least one evaporator coil; and
(ii) operating the refrigeration unit to cause the fan to draw air from the upper portion of the storage area and to force the air downward through the channel past the at least one evaporator coil under turbulent flow conditions and out the at least one opening at the bottom of the channel into the lower portion of the storage area and continuing to recirculate he air within the refrigeration unit in that manner.
